(19) United States
(12) Patent Application Publication
(10) Pub. No.: US 2014/0004444 A1
(43) Pub. Date: Jan. 2, 2014

(54) FUEL CELL ELECTROCATALYST

(71) Applicants: Isotta Cerri, Steenokkerzeel (BE); Tetsuo Nagami, Nagoya-shi (JP); Brian Elliott Hayden, Southampton (GB); Audrey Celine Vecoven, Southampton (GB); Claire Mormiche, Southampton (GB); Jonathan Conrad Davies, Southampton (GB)

(72) Inventors: Isotta Cerri, Steenokkerzeel (BE); Tetsuo Nagami, Nagoya-shi (JP); Brian Elliott Hayden, Southampton (GB); Audrey Celine Vecoven, Southampton (GB); Claire Mormiche, Southampton (GB); Jonathan Conrad Davies, Southampton (GB)

(21) Appl. No.: 13/876,209

(22) PCT Filed: Sep. 28, 2010
(86) PCT No.: PCT/EP2010/005907

§ 371 Date: Sep. 23, 2013

(51) Int. Cl. H01M 4/92; H01M 4/86

(52) U.S. Cl. CPC H01M 4/925; H01M 4/8657
USPC 429/487; 429/489

(57) ABSTRACT

An object of the present invention is to develop a support for PEMFC electrocatalyst with enhanced electrical conductivity and stability in acidic environment.

The object can be achieved by a support material comprising a Ti—Nb composite oxide having rutile crystal structure,

### TECHNICAL FIELD

The present invention relates to support materials for fuel cell electrocatalysts, and fuel cell electrocatalysts comprising said support material,

### BACKGROUND ART

The durability of conventional proton exchange membrane fuel cells (PEMFC) is limited by the presence of carbon as catalyst support material. In PEMFC if carbon is used as a support material for electrocatalysts, a reaction that oxidizes carbon to CO₂ proceeds in presence of water and in the relevant potential range of operation (above 0.2 V, SHE basis, especially more than 1.0 V). Carbon oxidation results in catalyst thinning with consequent loss of performances. The durability of the electrode material may be enhanced by the use of composite oxides due to their stability in typical acidic environments.

Such a material is disclosed in WO 2009/152003 which describes the use of titanium oxide (TiO₂) doped with niobium (Nb) as support for an electrocatalyst. In the case of the electrode described in the document, a specific reducing treatment at high temperature is applied to the composite oxide to enhance the electrical conductivity via the formation of a crystalline rutile phase including the lower oxidation state Ti₄O₇ (Magneli phase). The composite oxide includes Nb in an amount preferably in the range of 5-10 at. % relative to the sum of Ti and Nb. The achieved electrical conductivity is lower than 0.16 S/cm.

U.S. Pat. No. 6,524,750 describes a compound represented by the formula Ti₁₋ₓNbₓO_{2-y} in which x is 0.01 to 0.5 and y is 0.05 to 0.25. The compound includes a rutile phase and exhibits improved electrical conductivity. As described in the U.S. Pat. No. 6,524,750, a very high temperature synthesis at 1250° C. is followed by a high temperature reduction treatment in H₂ atmosphere, resulting in sub-stoichiometries. The compound is used as an additive for primary and secondary battery cells to improve discharge capacity. While certain composite oxides have been disclosed for electrochemical applications such as catalyst supports and additives, there still remains a need for improvement for such materials with respect to areas such as conductivity, catalyst dissolution and catalytic activity.

### DISCLOSURE OF THE INVENTION

### Objects to be Achieved by the Invention

An object of the present invention is to develop a support for PEMFC electrocatalyst with enhanced electrical conductivity and stability in acidic environment.

### Means for Attaining the Objects

As a result of intensive studies to achieve the above object, the present inventors have developed a composite oxide material with enhanced electrical conductivity and stability in acid as an alternative to carbon catalyst supports.

Specifically, the present invention is summarized as follows.

(1) A supported fuel cell electrocatalyst comprising:
a support material comprising a Ti—Nb composite oxide having rutile crystal structure; and
a precious metal catalyst supported on the support material.

(2) The supported fuel cell electrocatalyst according to (1), wherein an amount of Nb in the composite oxide is in the range of 5-20 at. % with respect to the sum of Ti and Nb.

(3) The supported fuel cell electrocatalyst according to (2), wherein an amount of Nb in the composite oxide is preferably in the range of 6-8 at. % with respect to the sum of Ti and Nb.

(4) The supported fuel cell electrocatalyst according to any one of (1)-(3), wherein the precious metal catalyst is a platinum catalyst.

(5) The supported fuel cell electrocatalyst according to any one of (1)-(4), wherein an amount of the precious metal catalyst is in the range of 10-50% by weight with respect to the support material.

(6) The supported fuel cell electrocatalyst according to any one of (1)-(5), wherein the Ti—Nb composite oxide is a near-stoichiometric rutile composite oxide.

(7) The supported fuel cell electrocatalyst according to any one of (1)-(6), wherein the Ti—Nb composite oxide is in a film or powder form.

(8) A method for the production of a Ti—Nb composite oxide having rutile crystal structure, comprising:
doping TiO₂ with Nb at a temperature 600-800° C. under a weak oxygen atmosphere.

### Effects of the Invention

According to the present invention, a Ti—Nb composite oxide with enhanced electrical conductivity and stability in acid as catalyst support can be provided. Thin films of Nb doped titanium in the high temperature rutile phase can be prepared with enhanced stability and electrical conductivity. Oxygen near-stoichiometry of the Nb doped titanium oxide promotes higher electrical conductivity, making the oxide a suitable candidate for FC catalyst support with long term stability.

### BRIEF DESCRIPTION OF DRAWINGS

FIG. 1 shows XRD patterns of rutile composite oxides.

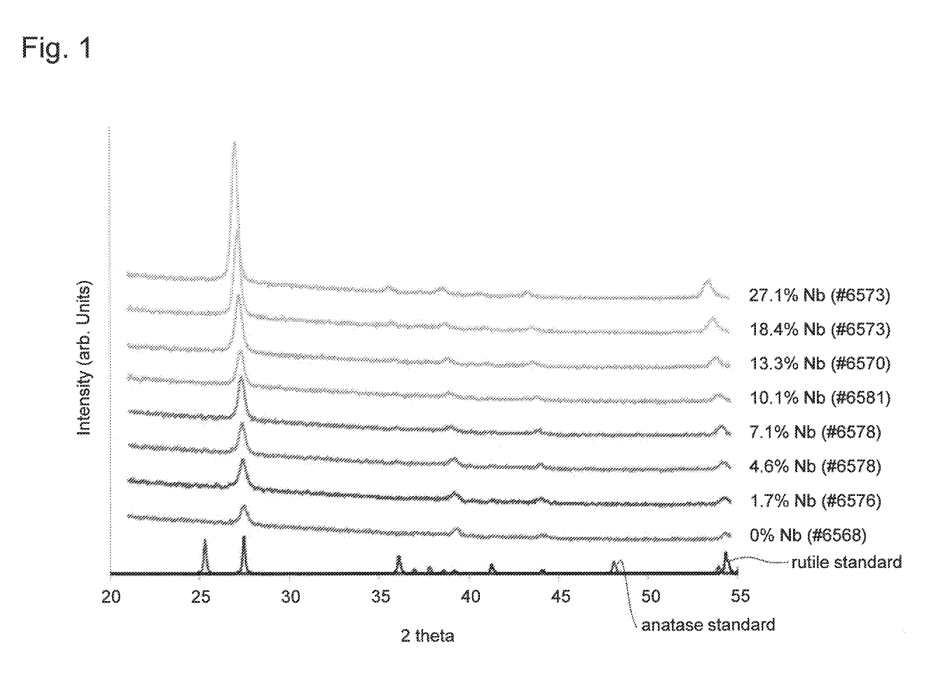

FIG. 2 shows electrical conductivity for the amorphous and rutile near-stoichiometric composite oxide films.

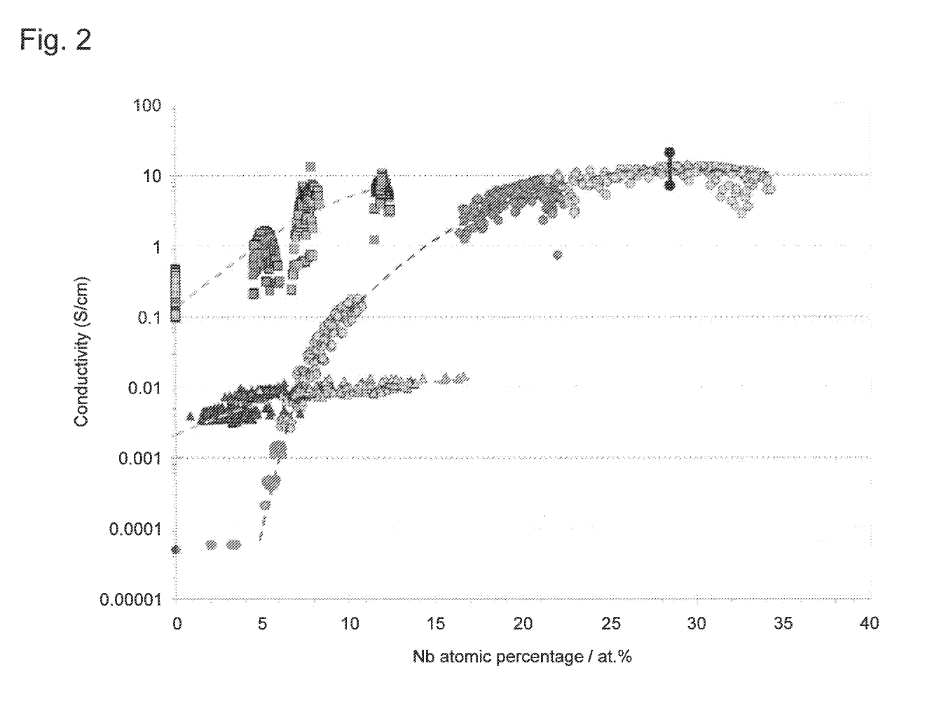

FIG. 3 shows typical TEM image of Pt particles deposited on composite oxide.

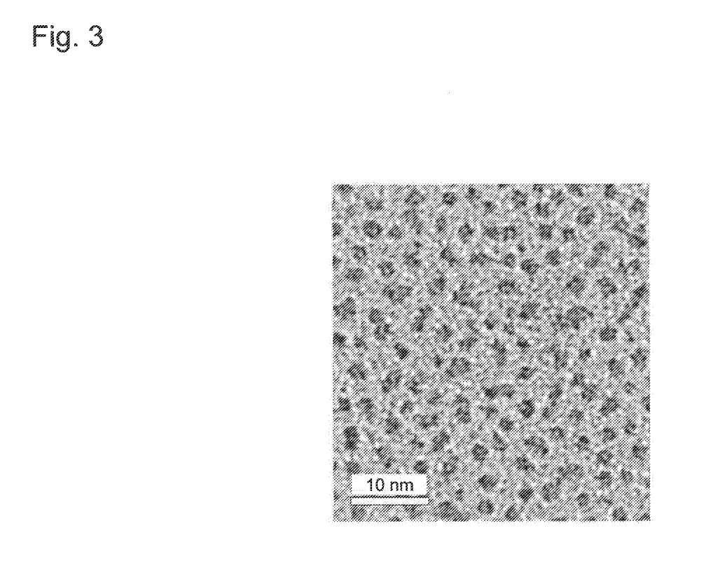

FIG. 4 shows third cathodic cycle of voltammetry performed at 20 mVs-1 in oxygenated 0.5M HClO₄ solution, but with no electrode rotation, for full stoichiometric rutile composite oxide.

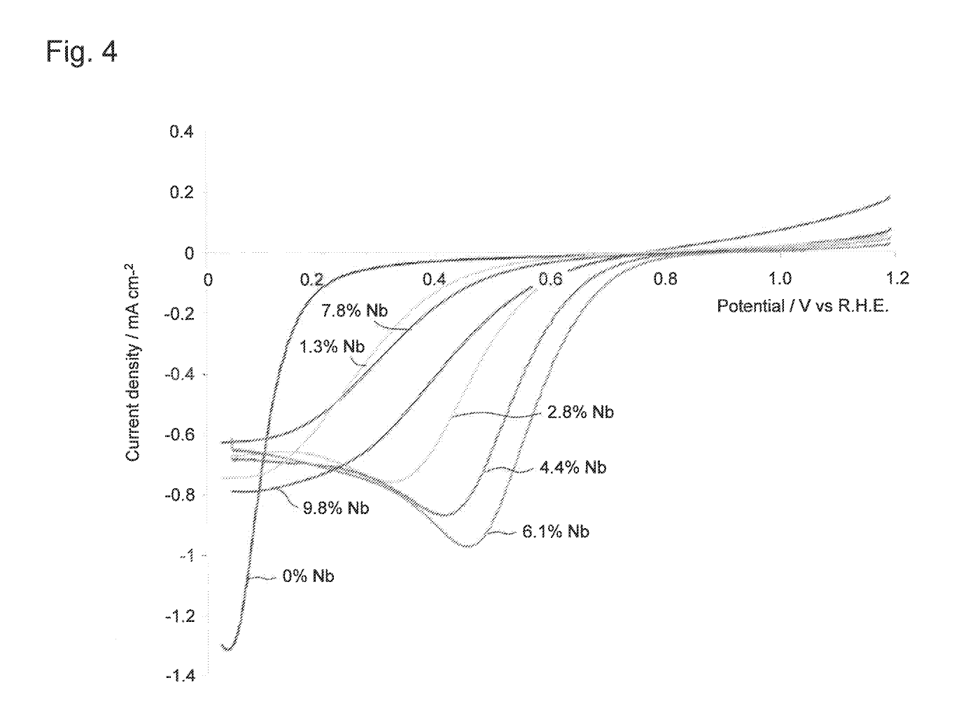

FIG. 5 shows cathodic cycle of voltammetry performed at 20 mVs-1 in oxygenated 0.5M HClO₄ solution, but with no electrode rotation, for the best-performing amorphous, anatase and rutile substrates.

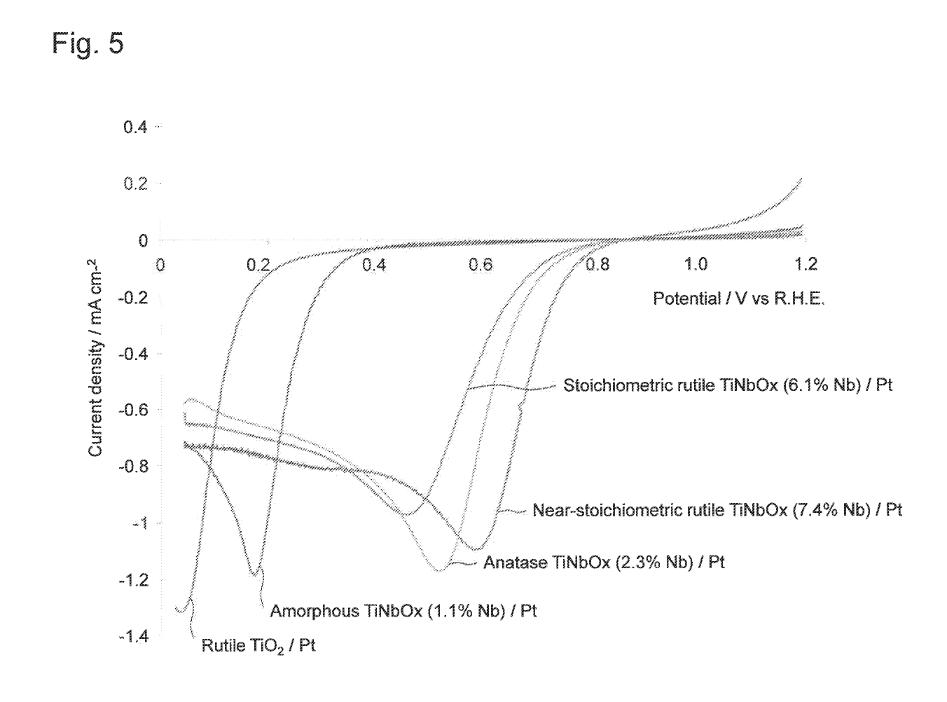

FIG. 6 shows sample rutile TiNbOₓ (5.4-10.2 at. % Nb) after exposure to 0.1M H₂SO₄ at 80° C. for a) 0 hours; h) 2 hours; c) 4 hours; d) 6 hours; e) 24 hours.

FIG. 7 shows sample ruffle TiNbOₓ (11.7-30.5 at. % Nb), after exposure to 0.1M H₂SO₄ at 80° C. for a) 0 hours; b) 2 hours; c) 4 hours; d) 6 hours; e) 24 hours.

FIG. 8 shows sample amorphous TiNbOₓ (11.7-30.5 at. % Nb), after exposure to 0.1M H₂SO₄ at 80° C. for a) 0 hours; b) 2 hours; c) 4 hours; d) 6 hours; e) 24 hours

FIG. 9 shows change in the relative Nb:Ti percentage after exposure to 0.1M H₂SO₄ at 80° C. for a 24 hour period.

FIG. 10 shows conductivity map for sample quartz/TiNbOₓ (3.2-13.5 at. % Nb): a) before stability test, b) after stability test.

FIG. 11 shows cathodic cycle of voltammetry at 20 mVs-1 in oxygenated 0.5M HClO₄ solution, but with no electrode rotation, for full stoichiometric, near-stoichiometric and amorphous rutile composite oxide.

### BEST MODE FOR CARRYING OUT THE INVENTION

### Ti—Nb Composite Oxide

The composite oxide is a compound formed by doping titanium oxide (TiO₂) with niobium (Nb). In general, the presence of the Nb⁵⁺ dopant promotes the formation of Ti³⁺ in the TiO₂ structure resulting in enhanced electrical conductivity. An amount of Nb in the Ti—Nb composite oxide of the present invention is preferably in the range of 5-20 atomic (at.) %, more preferably in the range of 5-15 at. %, and even more preferably in the range of 6-8 at.% with respect to the sum of Ti and Nb.

Since a crystalline rutile oxide shows a higher oxidation reduction. onset potential than an amorphous composite oxide or an anatase crystalline oxides, a rutile crystalline composite oxide is used as support for the electro-catalysts.

The stoichiometry of the rutile oxide can be varied depending on the oxidative conditions of the preparation method. Since a near-stoichiometric rutile composite oxide shows a higher oxidation reduction onset potential than a full stoichiometric one, a near-stoichiometric ruffle composite oxide is preferably used as support for the electro-catalysts. The near-stoichiometric rutile composite oxide can be represented, for example, by the formula Ti₁₋ₓNbₓO_{y} (wherein x is 0.05-0.2 and y is 1.95-2).

An electrocatalyst having excellent electrochemical properties can be obtained with the use of a composite oxide having the above rutile crystalline and near-stoichiometry structure as a support.

### Crystallinity

Crystallinity of all the above composite oxides has been confirmed by measuring X-ray diffraction spectra. No other secondary phases have been detected, such as Nb₂O₅ or Ti₄O₇ Magneli phases.

Magneli phase is undesirable and provides and has shown to be thermally instable. In the Ti—Nb composite oxide of the present invention, Magneli phase is eliminated or minimized by providing near-stoichiometric/stoichiometric Ti—Nb composite oxide in rutile phase. This is one aspect of improved performance over prior art.

### Chemical Composition

The chemical composition of all the above composite oxide (the atomic percentage of Nb with respect of the sum of Ti and Nb) has been identified by energy dispersive X-ray spectrometry and Laser Ablation inductively Coupled Plasma spectrometry.

### Electrical Conductivity

Electrical conductivity has been measured on all the above crystalline structures.

It was found that all the amorphous near-stoichiometric composite oxides have a conductivity higher than 1×10⁻³ S/cm, while all the amorphous stoichiometric composite oxides have a conductivity much lower than 1×10⁻⁶ S/cm.

It was found that all the anatase composite oxides have a conductivity lower than 1×10⁻⁶ S/cm independent of the oxygen. stoichiometry and Nb content.

It was found that all the rutile stoichiometric composite oxides have a low conductivity, lower than 1×10⁻⁶ S/cm, while the rutile near-stoichiometric composite oxides can have conductivities in the range 0.01-10 S/cm, with a positive effect of the Nb content.

### Stability in Acid

Stability in acid has been measured on the composite oxides with the highest electrical conductivity, meaning amorphous and rutile phases. Anatase composite oxides have not been tested because of the high electrical resistivity. The test consisted in suspending the samples in 200 mL of 0.1M of H₂SO₄ at 80° C. for 24 h.

It was found that all the amorphous composite oxides easily dissolve in acid media, with some stability enhancement only for Nb above 20 at.%.

It was found that all the rutile composite oxides (either full or near-stoichiometric) are stable in acidic media at high temperatures in the range of 80-85° C. with a slight loss in stability for Nb above 20 at. %.

Therefore, a composite oxide having high acid resistance and high electron conductivity can be obtained by doping near-stoichiometric rutile Ti oxide with Nb % in the range 5-20 at. %, with best conductivity between 5-15 % Nb.

The composite oxide may be in a film or powder form. In the case of the film form, the average film thickness is preferably 100-1000 nm. When the composite oxide is in powder form, powder particles are preferably spherical with average particle size 10-100 nm.

An electrocatalyst with high strength and a large surface area can be produced with the use of a composite oxide in film or powder forms, as described above.

### Electrocatalyst

The electrocatalyst is an electrode material having catalyst activity which comprises the before mentioned support containing a composite oxide and a catalyst supported by this support.

An example of catalyst is a precious metal, preferably platinum, or platinum alloy containing platinum or any other precious metal and a transition metal. An amount of the catalyst is preferably in the range of 10-50% by weight relative to the support. When platinum is used as the catalyst, a supported electrocatalyst provides high catalytic performance due to a strong metal support interaction (SMSI) between Pt and Ti—Nb composite. In the case that an amount of Nb in the Ti—Nb composite oxide is in the range of 6-8 at. % with respect to the sum of Ti and Nb, higher catalytic performance is provided. Provide list of other precious metals that may be used as a catalyst.

The superior properties of the present invention is due to 1) improved conductivity due to rutile phase, and 2) SMSI effect between Pt and Ti—Nb composite.

Preferably the catalyst is in a spherical form with average particle size 1 to 10 nm.

An electrocatalyst having high catalyst activity can be obtained with the use of the above catalyst.

In the case of an eletrocatalyst comprising a support containing an amorphous composite oxide, the activity towards the oxygen reduction reaction is very low and almost independent on Nb content and stoichiometry level.

In the case of a support containing an anatase composite oxide, the activity towards the oxygen reduction reaction is enhanced and the oxygen reduction peak shifts to more positive potential, i.e 0.5-0.6V vs SHE.

In the case of a support containing a stoichiometric rutile composite oxide, we found the highest activity for 6.1% Nb concentration. For comparison, a near-stoichiometric rutile composite oxide with 7.4% Nb amount has been tested and showed the highest onset potential for the oxygen reduction.

### Method for Production of Electrocatalyst

When the electrocatalyst is in a film form, and contains an amorphous composite oxide as a support, the electrocatalyst can be produced by a synthesis step of doping TiO₂ with Nb so as to synthesize an amorphous composite oxide, and a catalyst supporting step of allowing the composite oxide to support a catalyst.

When the electrocatalyst is in a film form, and contains an anatase crystalline composite oxide as a support, the electrocatalyst can be produced by a synthesis step of doping TiO₂ with Nb at temperature 400-600° C. so as to synthesize an anatase composite oxide, and a catalyst supporting step of allowing the composite oxide to support a catalyst.

When the electrocatalyst is in a film form, and contains a rutile crystalline composite oxide as a support, the electrocatalyst can be produced. by a synthesis step of doping TiO₂ with Nb at a temperature of 600-900° C. so as to synthesize a rutile crystalline oxide, and a catalyst supporting step of allowing the composite oxide to support a catalyst.

When the electrocatalyst is in a film form, and contains a near-stoichiometric composite oxide as a support, the synthesis step is carried out in an O₂-poor atmosphere.

Each step is described below.

### Synthesis Step

A composite oxide comprising Nb-doped TiO₂ can be synthesized by different methods, for instance by PVD methods (i.e. molecular beam deposition, vacuum deposition, ion plating or sputtering) on different type of substrates, such as Si, glass, Si/TiW, etc. Preferably molecular beam deposition is carried out.

When molecular beam is carried out, it is preferable to supply oxygen gas at a pressure of 1×10⁻⁷ to 5×10⁻⁵/Torr and apply electric power of 300 to 400 W.

An amorphous composite oxide in a film form can be synthesized without applying any heating to the substrate. Amorphous stoichiometric composite oxides were prepared by depositing the metals whilst using the atomic oxygen plasma source at a power of 300 W and at a pressure of 5×10⁻⁵ Torr of oxygen, Amorphous near-stoichiometric composite oxides were prepared by depositing the metals whilst using the molecular oxygen plasma source at a power of 300 W and at a pressure of 1×10⁻⁵ Torr of oxygen.

Anatase crystalline composite oxides were produced by heating the substrate at 400-550° C. Anatase stoichiometric composite oxides were prepared by depositing the metals whilst using the atomic oxygen plasma source at a power of 300 W and at a pressure of 5×10⁻⁵ Torr of oxygen. Anatase near-stoichiometric composite oxides were prepared by depositing the metals whilst using the molecular oxygen plasma source at a power of 300 W and at a pressure of 1×10⁻⁵ Torr of oxygen.

Rutile crystalline composite oxides were produced by heating the substrate at 600-800° C. Rutile stoichiometric composite oxides were prepared by depositing the metals whilst using the atomic oxygen plasma source at a power of 300 W and at a pressure of 5×10⁻⁵ Torr of oxygen, Rutile near-stoichiometric composite oxides were prepared by depositing the metals whilst using the molecular oxygen plasma source at a power of 400 W and at a pressure of 5×10⁻⁶ Torr, or an atomic oxygen plasma source at a power of 400 W and at a pressure of 3×10⁻⁷ to 5×10⁻⁶ Torr of oxygen.

### Catalyst Supporting Step

The purpose is to deposit on the composite oxide a catalyst so as to prepare an electrocatalyst, This step can be carried out via the physical vapor deposition (PVD) method, as in the case of the above synthesis step. Preferably molecular beam deposition is used. When molecular beam deposition is used, the maximum evaporation rate is preferably 1 to 3×10⁻² Å s⁻¹. Pt particles of average 2-3 nm particle size are deposited on the thin film composite oxides.

The present invention will be further described in the following Examples.

### EXAMPLE

### A) Stability of Rutile Near-Stoichiometric TiNbOₓ in Acid at High Temperature:

Stability tests have been carried out on the relevant rutile Ti—Nb Oxides Films

### Samples:

Two sets of samples were prepared and analyzed according to the stability protocol defined below:
(a) thin film rutile TiNbOₓ (Nb=0-25 at. %) samples on Si substrates to check thickness and chemical composition
(b) thin films TiNbOₓ (Nb−0-25 at. %) samples on quartz substrates to look at the effect on conductivity, prior to, and post-acid exposure. (Conductivity was not measured on samples 1.)

### Stability Test Protocol:

The samples used were immersed in 200 mL of 0.1 M H₂SO₄ at 80° C. for a period of 24 hours. Being 80° C. the maximum temperature expected in state-of-the-art PEMFC.

Analysis:
(1) Thickness measurement by optical analysis by imaging of samples before/during/after stability test
(2) Chemical composition by ICP-MS analysis of samples before/during/after stability test
(3) Conductivity by 4-points probe analysis before and after stability test

Results:
(1) Thickness measurement by optical analysis

Photographs of the samples were obtained after 0, 2, 4, 6 and 24 hours. According to optical imaging, there is no change in the color appearance meaning that there is no change in the thickness of the thin films, no remarkable dissolution taking place.

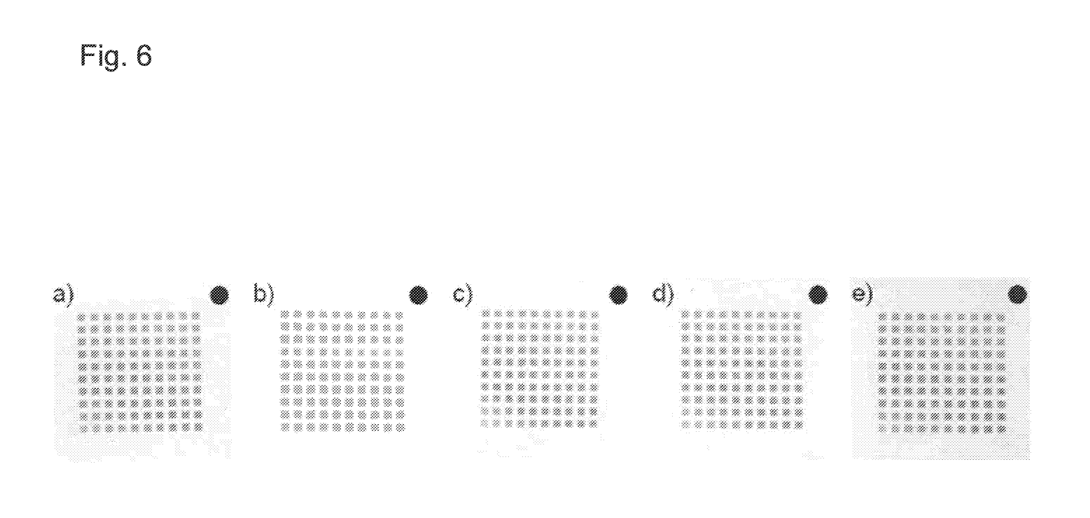

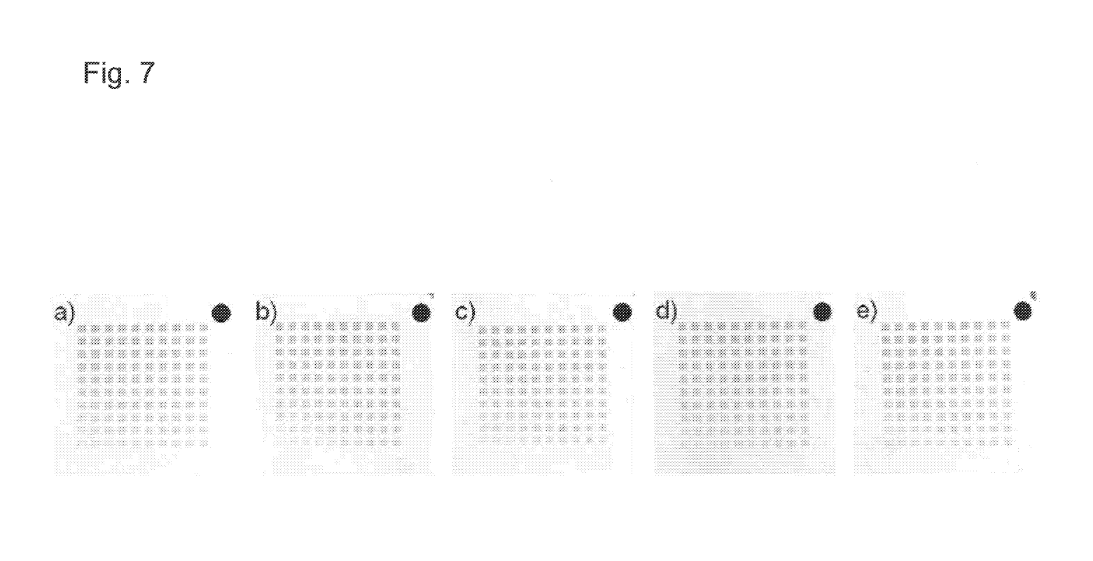

None of the samples investigated (0-25 at. % Nb composition) showed any visible signs of damage or corrosion on exposure to the hot acid, examples given in FIGS. 6 and 7.

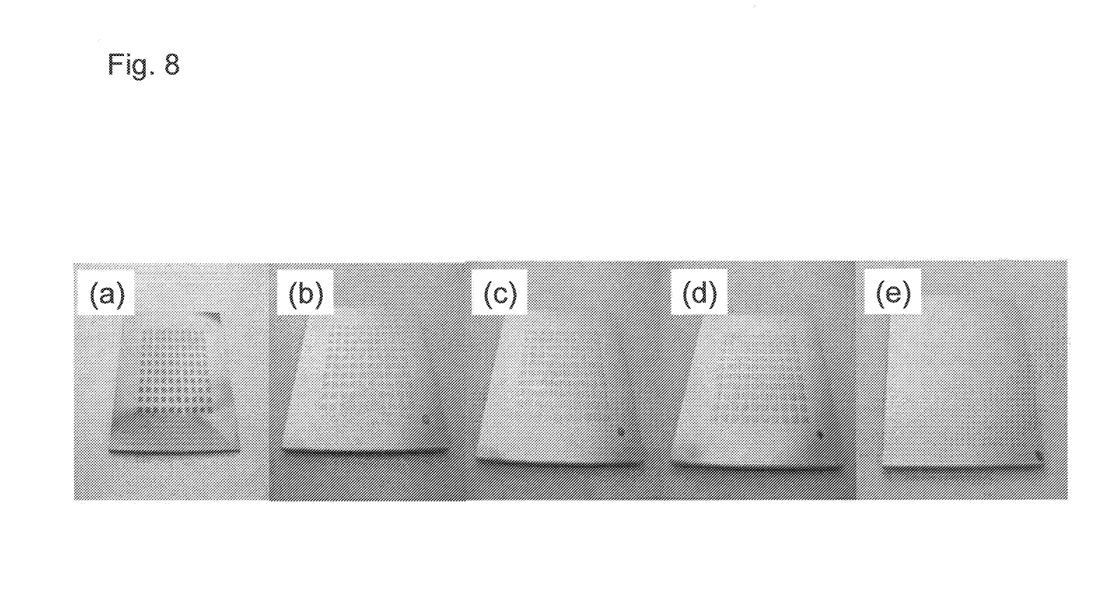

For comparison FIG. 8 shows the effect of the same acid treatment on amorphous TiNbOₓ. As it can be seen, there is a remarkable change in color/thickness as results of the dissolution of the thin film.

This result was confirmed in all the prepared samples Examples given in FIG. 6, 7.

### (2) Compositional Analysis by ICP-MS

In order to determine whether there was any compositional change, for example due to preferential dissolution of one element, ICP-MS was performed on the four corners, and the central field, of the library prior to and after the acid exposure.

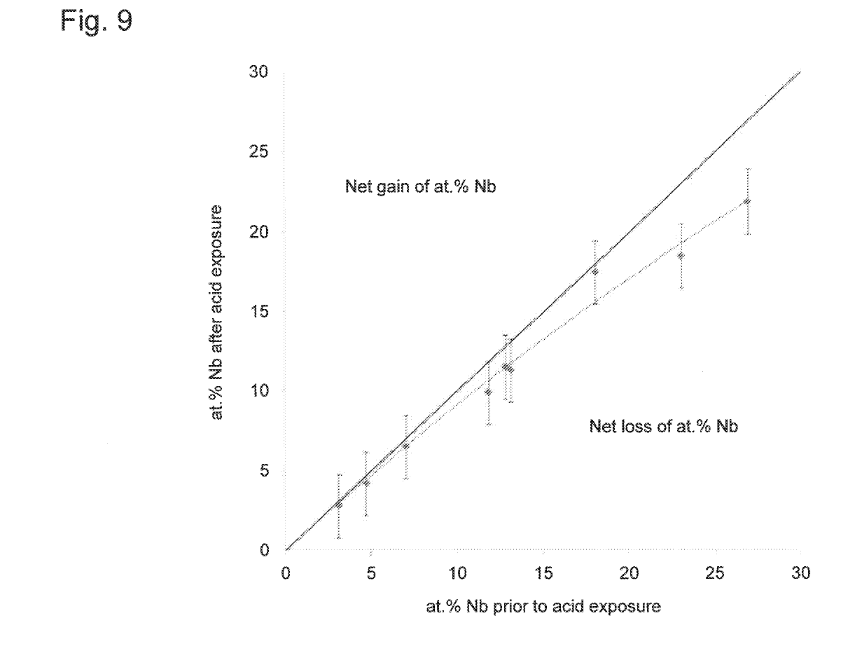

FIG. 9 presents a plot displaying the at. % Nb after the exposure to acid versus the original composition for the three different sets of conditions used. In general, there is no strong evidence of any loss or gain of Nb for any of the preparation conditions used, between 0-10%, however at higher percentages some deviation is observed.

On the more stoichiometric samples there is evidence of a loss of Nb versus Ti. It has been proposed that above ˜13%, Nb begins to fill interstitial sites, less stable in the acid environment.

Conversely, for the less stoichiometric samples there is a slight enrichment of Nb versus Ti (i.e. a preferential loss of Ti) at higher Nb concentrations, due to the lower degree of crystallinity, as confirmed in the amorphous films.

### (3) Across Film Conductivity Measurements

For each of the relevant thin film oxides prepared on the quartz substrates, four point probe (4PP) conductivity measurements have been performed in order to obtain their resistivity.

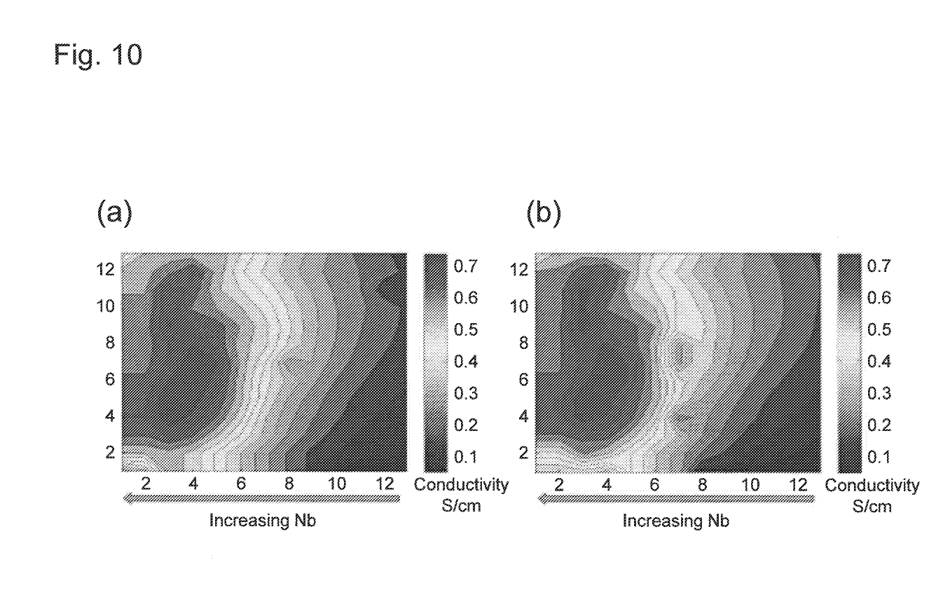

It was seen from all different libraries that the exposure to 0.1 M H₂SO₄ at 80° C. for 2.4 hours had little to no effect on the conductivity of any of the films. It was demonstrated that there was no obvious visible effect on the films during this acid treatment whilst any gain or loss of Nb was only observed for the high Nb compositions. At these higher compositions, any deviation in the composition would only be expected to lead to minimal change in the conductivity of the film, hence this is consistent with the conductivity data. A macro showing the conductivity data for TiNbOₓ (3.2-13.5 at. % Nb) is shown below in FIG. 10, demonstrating that there is little to no observable change across an individual film.

B) SMSI effect

We observed that the electrochemical performances of the Pt catalyst towards the oxygen reduction reaction are not merely depending on the electrical conductivity of the substrates.

Extensive electrochemical studies have been performed.

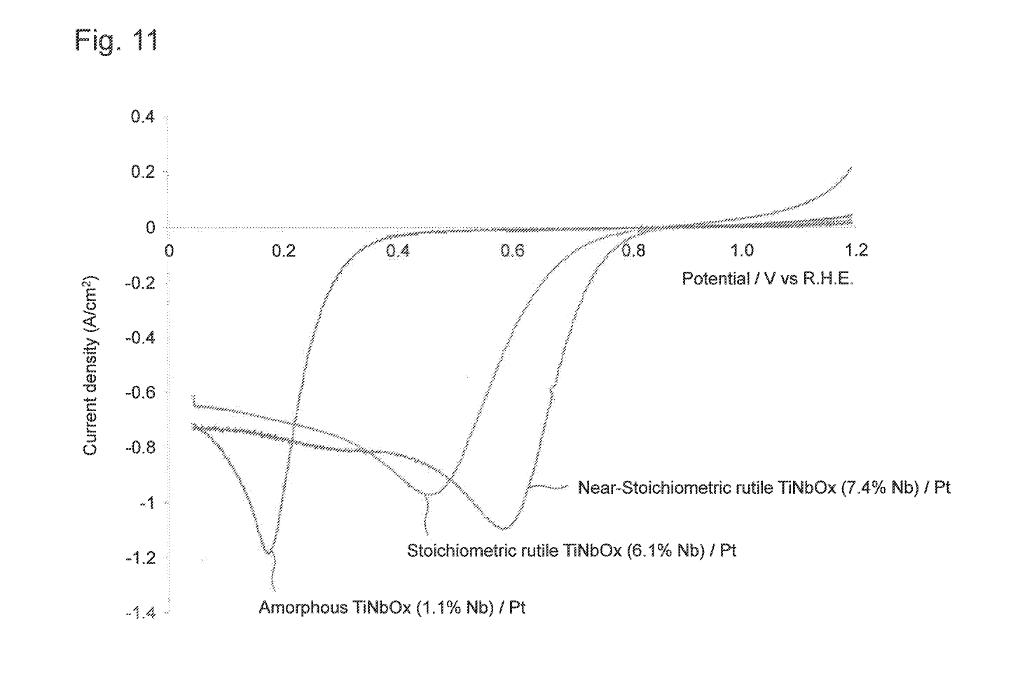

In FIG. 11, we can see that Pt particles (2 nm) deposited on rutile stoichiometric and near-stoichiometric oxides have similar performances, however the electrical conductivity levels are very different.

We verified in fact that all the rutile stoichiometric composite oxides have a low conductivity, lower than 1×10⁻⁶ S/cm, while the rutile near-stoichiometric composite oxides have conductivities as high as 10 S/cm, with a positive effect of the Nb content.

We expect indeed that the stronger metal support interaction between the Pt catalyst and the rutile TiNbOₓ support promotes the electrochemical reactions, less dependently on conductivities level.

C) Preparation Method (Near-Stoichiometry vs. Sub-Stoichiometry)

The synthesis route of the TiNbOₓ composite oxides is vastly different, resulting in different levels of oxygen sub-stoichiometry.

In the present invention, the composite oxides have been prepared by direct vacuum deposition on a 600° C. pre-heated substrate. We expect indeed near stoichiometric samples.

All publications, patents, and patent applications cited herein are incorporated herein by reference in their entirety.

1. A supported fuel cell electrocatalyst comprising:
a support material comprising a Ti—Nb composite oxide having rutile crystal structure; and
a precious metal catalyst supported on the support material.

2. The supported fuel cell electrocatalyst according to claim 1, wherein an amount of Nb in the composite oxide is in the range of 5-20 at. % with respect to the sum of Ti and Nb.

3. The supported fuel cell electrocatalyst according to claim 2, wherein an amount of Nb in the composite oxide is preferably in the range of 6-8 at. % with respect to the sum of Ti and Nb.

4. The supported fuel cell electrocatalyst according to any one of claims I wherein the precious metal catalyst is a platinum catalyst.

5. The supported fuel cell electrocatalyst according to any one of claims 1-4, wherein an amount of the precious metal catalyst is in the range of 10-50% by weight with respect to the support material.

6. The supported fuel cell electrocatalyst according to any one of claims 1-5, wherein the Ti—Nb composite oxide is a near-stoichiometric rutile composite oxide.

7. The supported fuel cell electrocatalyst according to any one of claims 1-6, wherein the Ti—Nb composite oxide is in a film or powder form.

8. A method for the production of a Ti—Nb composite oxide having rutile crystal structure, comprising:
doping TiO₂ with Nb at a temperature 600-800° C. under a weak oxygen atmosphere.
